(19) United States
(12) Patent Application Publication
(10) Pub. No.: US 2019/0372106 A1
(43) Pub. Date: Dec. 5, 2019

(54) ALL SOLID STATE BATTERY

(71) Applicant: TOYOTA JIDOSHA KABUSHIKI KAISHA, Toyota-shi (JP)

(72) Inventor: Masafumi NOSE, Susono-shi (JP)

(73) Assignee: TOYOTA JIDOSHA KABUSHIKI KAISHA, Toyota-shi, (JP)

(21) Appl. No.: 16/419,687

(22) Filed: May 22, 2019

(30) Foreign Application Priority Data
Jun. 1, 2018 (JP) 2018-106342
Apr. 1, 2019 (JP) 2019-070253

(51) Int. Cl. H01M 4/36; H01M 10/0562; H01M 4/58; H01M 4/38

(52) U.S. Cl. CPC H01M 4/364; H01M 10/0562; H01M 2004/028; H01M 4/38; H01M 4/5815

(57) ABSTRACT

An object of the present disclosure is to produce an all solid state battery in which the resistance increase during discharge is inhibited. The present disclosure achieves the object by providing an all solid state battery comprising a cathode layer, a solid electrolyte layer, and an anode layer in this order; wherein the cathode layer comprises a cathode active material including a S element, a sulfur containing compound including an M element, which is P, Ge, Sn, Si, B or Al, and a S element, a conductive auxiliary material, and substantially no Li element; and the solid electrolyte layer contains a garnet-type oxide solid electrolyte or β-alumina.

### TECHNICAL FIELD

The present disclosure relates to an all solid state battery.

### BACKGROUND ART

In accordance with the rapid spread of information-related apparatuses and communication devices such as a personal computer, a video camera, and a portable telephone in recent years, the development of a battery used for the power source thereof is regarded as important. Also in the automobile industry, the development of a battery with high out-put and high capacity for electric vehicles or hybrid vehicles is in progress.

The development of a sulfur battery using sulfur as a cathode active material is in progress. The sulfur has a feature that the theoretical capacity thereof is extremely high as 1675 mAh/g. Non-Patent Literature 1 discloses that a cathode mixture is produced by conducting mechanical milling to a mixture of sulfur (S), P₂S₅, and Ketjen black. Also, Non-Patent Literature 1 discloses that Li₃PS₄ glass is used for a solid electrolyte layer.

Also, Patent Literature 1 discloses an all solid lithium sulfur battery comprising a cathode containing sulfur and a conductive material, an anode containing a lithium metal, and a solid electrolyte layer interposed between the cathode and the anode. Also, Patent Literature 2 discloses a cathode material for a lithium sulfur solid state battery comprising sulfur, a conductive material, a binder, and an ionic solution or a solvated ionic solution.

### CITATION LIST

### Patent Literatures

Patent Literature 1: Japanese Patent Application Laid-Open (JP-A) No. 2017-168434
Patent Literature 2: JP-A No. 2017-168435

### Non-Patent Literature

Non-Patent Literature 1: N. Tanibata et al., “A novel discharge-charge mechanism of a S-P2S5 composite electrode without electrolytes in all-solid-state Li/S batteries”, J. Mater. Chem. A, 2017 5 11224-11228

### SUMMARY OF DISCLOSURE

### Technical Problem

Higher performance of a battery has been required. The present disclosure has been made in view of the above circumstances, and a main object thereof is to provide an all solid state battery in which the resistance increase during discharge is inhibited.

### Solution to Problem

The present disclosure provides an all solid state battery comprising a cathode layer, a solid electrolyte layer, and an anode layer in this order; wherein the cathode layer comprises a cathode active material including a S element, a sulfur containing compound including an M element, which is P, Ge, Sn, Si, B or Al, and a S element, a conductive auxiliary material, and substantially no Li element; and the solid electrolyte layer contains a garnet-type oxide solid electrolyte or β-alumina.

According to the present disclosure, the specific cathode layer and the specific solid electrolyte layer are used in combination and thus the resistance increase during discharge may be inhibited in an all solid state battery.

In the disclosure, a proportion of the Li element may be 0 mol % or more and 20 mol % or less.

In the disclosure, the M element may be a P element.

In the disclosure, the garnet-type oxide solid electrolyte may have a composition represented by a general formula (Li_{x-3y-z}, E_{y}, H_{z})L_{α}M_{β}O_{γ}, in the formula, E is at least one kind of Al, Ga, Fe, and Si, H is a hydrogen element, L is at least one kind of an alkali earth metal and lanthanoid element, M is at least one kind of a transition element that can be six-coordinated with oxygen, and a typical element belonging to 12^{nd} to 15^{th} groups in the periodic table, O is an oxygen element, x, y, z satisfy 3≤x−3y−z≤7, 0≤y, and 0≤z, α, β, γ may respectively satisfy 2.5≤α≤3.5, 1.5≤β≤2.5, and 11≤γ≤13.

### Advantageous Effects of Disclosure

The all solid state battery in the present disclosure exhibits effects such that the resistance increase during discharge may be inhibited.

### BRIEF DESCRIPTION OF DRAWINGS

FIG. 1 is a schematic cross-sectional view illustrating an example of the all solid state battery in the present disclosure.

FIG. 2 is a flow chart explaining an example of the method for producing the cathode mixture in the present disclosure.

FIGS. 3A to 3C are the results of an XRD measurement for the raw materials (P₂S₅ and S) in Example 1 and for the cathode mixtures obtained in Example 1.

FIG. 4 is the result of a resistance measurement for the all solid state batteries obtained in Example 1 and Comparative Example 1.

FIGS. 5A to 5C are the results of an XRD measurement for the cathode mixtures obtained in Reference Examples 1 to 3.

### DESCRIPTION OF EMBODIMENTS

The all solid state battery in the present disclosure will be hereinafter described in details.

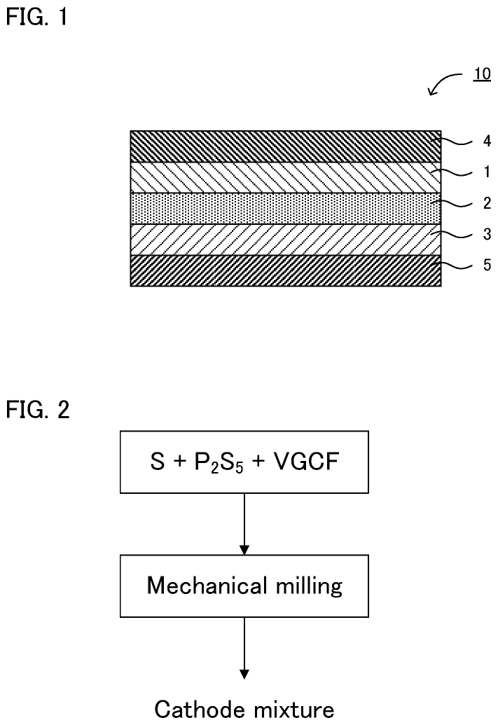

FIG. 1 is a schematic cross-sectional view illustrating an example of the all solid state battery in the present disclosure. All solid state battery 10 illustrated in FIG. 1 comprises cathode layer 1, solid electrolyte layer 2, and anode layer 3 in this order. All solid state battery 10 further comprises cathode current collector 4 for collecting currents of cathode layer 1, and anode current collector 5 for collecting currents of anode layer 3. Cathode layer 1 comprises: a cathode active material including a S element; a sulfur containing compound including an M element, which is P, Ge, Sn, Si, B or Al, and a S element; a conductive auxiliary material; and substantially no Li element. In addition, solid electrolyte layer 2 contains a garnet-type oxide solid electrolyte or β-alumina, as a solid electrolyte.

According to the present disclosure, the specific cathode layer and the specific solid electrolyte layer are used in combination and thus the resistance increase during discharge may be inhibited in an all solid state battery.

As described above, Non-Patent Literature 1 discloses a cathode mixture using a mixture of sulfur (S), P₂S₅, and Ketjen black as raw materials. Further, Non-Patent Literature 1 discloses that Li₃PS₄ glass is used for a solid electrolyte layer. When the cathode mixture was used for a cathode layer and a soft materials such as Li₃PS₄ glass was used for a solid electrolyte layer, as described in Comparative Example 1 later, a new problem arose such that the resistance increase of a battery occurred during discharge. To solve such a problem, the inventor thoroughly researched and confirmed that the resistance increase during discharge was inhibited by using a hard material for the solid electrolyte layer.

Here, the reason why the resistance increase of a battery occurs during discharge is presumed as follows. For example, a cathode mixture using a mixture of sulfur (S), P₂S₅, and conductive auxiliary material, as raw materials, is a soft material since a S element is included. Meanwhile, a sulfide solid electrolyte such as Li₃PS₄ glass is also a soft material in the same manner since a S element is included. It is presumed that a uniform interface is formed between a soft cathode layer and a soft solid electrolyte layer.

As the result, Li uniformly reacts with the cathode active material in the interface during discharge, and thus the concentration of Li presumably occurs in the width direction (direction orthogonal to the thickness direction). While a sulfur-containing compound derived from P₂S₅ (such as PS₄ structural skeleton) is present in the cathode layer, the concentration of Li occurs in the width direction to form the state where the ion conductor (ion conductor containing Li) is present in the interface uniformly in the width direction, which presumably becomes the resistance component and thereby the resistance increase of the battery occurs during discharge.

To solve such a problem, the all solid state battery in the present disclosure comprises a hard solid electrolyte layer using a specific oxide, but not a soft solid electrolyte layer using a sulfide solid electrolyte. Accordingly, it is presumed that a non-uniform interface is formed between a soft cathode layer and the hard solid electrolyte layer.

As the result, Li non-uniformly reacts with the cathode active material in the interface during discharge and thus the concentration of Li presumably occurs in the thickness direction. The concentration of Li occurs in the thickness direction, and thus the state where the ion conductor (ion conductor containing Li) is present in the interface uniformly in the width direction is not easily formed, which presumably results in inhibiting the resistance increase during discharge. Incidentally, the Li moved in the thickness direction (such as the Li moved to the region in the vicinity of the cathode current collector of the cathode layer) moves also in the width direction as the discharge proceeds, which presumably causes a battery reaction in the cathode layer overall.

Also, as described above, Patent Literature 1 discloses an all solid lithium sulfur battery comprising a cathode containing sulfur and a conductive material, an anode containing a lithium metal, and a solid electrolyte layer interposed between the cathode and the anode, wherein the solid electrolyte layer contains an oxide-based solid electrolyte. However, since the cathode layer in Patent Literature 1 does not include an ion conductor, the ion conducting path in the cathode layer is insufficient and thus the availability of cathode active material becomes low. On the other hand, in the present disclosure, since the cathode layer comprises a sulfur containing compound, the ion conducting path in the cathode layer is secured and thus the availability of cathode active material may be improved.

Also, the cathode layer in the present disclosure comprises substantially no Li element so as to inhibit the capacity from being degraded. Here, a cathode mixture containing an ion conductor (solid electrolyte) including a Li element has been known. For example, when an ion conductor using Li₂S is used as a raw material, a battery using such a cathode mixture in a cathode layer tends to have low capacity since the water resistance of Li₂S is low. To solve the problem, the cathode layer in the present disclosure comprises substantially no Li element (that is, Li₂S) so as to inhibit the capacity from being degraded.

“Comprising substantially no Li element” signifies that the proportion of the Li element to all the elements included in the cathode mixture is 20 mol % or less. The proportion of the Li element may be 16 mol % or less, may be 8 mol % or less, may be 4 mol % or less, and may be 0 mol %. Also, the cathode mixture in the present disclosure may contain substantially no Na element. “Containing substantially no Na element” signifies that the proportion of the Na element to all the elements included in the cathode mixture is 20 mol % or less. The proportion of the Na element may be 16 mol % or less, may be 8 mol % or less, may be 4 mol % or less, and may be 0 mol %.

1. Cathode Layer

The cathode layer comprises a cathode active material including a S element, a sulfur containing compound including an M element, which is P, Ge, Sn, Si, B or Al, and a S element, a conductive auxiliary material. Meanwhile, the cathode layer comprises substantially no Li element.

(1) Cathode Active Material

The cathode active material includes a S element. Above all, the cathode active material is preferably elemental sulfur. Examples of the elemental sulfur may include S₈ sulfur. The S₈ sulfur has three crystal forms of αsulfur (rhombic sulfur), βsulfur (monoclinic sulfur), and γsulfur (monoclinic sulfur), but any of them may be applicable.

When the cathode layer contains the elemental sulfur as a cathode active material, the cathode mixture may and may not have the peak of the elemental sulfur in an XRD measurement. The typical peaks of the elemental sulfur appear at 2θ=23.05°±0.50°, 25.84°±0.50°, and 27.70°±0.50° in an XRD measurement using a CuKα ray. These peak positions may be respectively ±0.30°, and may be ±0.10°.

A part or whole of the elemental sulfur may be dissolved in the later described sulfur containing compound. In other words, the cathode active material may contain a solid solution of the elemental sulfur and the sulfur containing compound. Also, a S element in the elemental sulfur and a S element in the sulfur containing compound may have a chemical bond (S—S bond). Incidentally, the content of the cathode active material in the cathode layer is the same as the content of the cathode active material in the later described raw material mixture; thus, the description herein is omitted.

(2) Sulfur Containing Compound

The cathode mixture in the present disclosure includes an M element, which is P, Ge, Sn, Si, B or Al, and a S element. Also, the cathode mixture may contain just one kind of the sulfur containing compound, and may contain two kinds or more thereof.

Meanwhile, the sulfur containing compound in the present disclosure substantially contains no Li element. Also, it is preferable that the sulfur containing compound becomes an ion conducting path during charge and discharge. Here, Li ions are conducted from the anode layer to the cathode layer via the solid electrolyte layer during discharge, and the Li ions reached at the cathode layer react with cathode active materials. When the sulfur containing compound is not present in the cathode layer, the ion conductivity of the corona product (such as Li₂S) is low; thus the discharge reaction does not easily proceed due to lack of the ion conducting path in the cathode layer. On the other hand, when the sulfur containing compound is present in the cathode layer, the ion conducting path in the cathode layer is secured by the sulfur containing compound and thus the discharge reaction easily proceeds even if the ion conductivity of the corona product (such as Li₂S) is low.

The sulfur containing compound preferably contains an ortho structural skeleton of an M element. Examples of the ortho structural skeleton may include a PS₄ structural skeleton, a GeS₄ structural skeleton, a SnS₄ structural skeleton, a SiS₄ structural skeleton, a BS₃ structural skeleton, and an AlS₃ structural skeleton. The sulfur containing compound may contain just one kind of the ortho structural skeleton, and may contain two kinds or more thereof. Meanwhile, the sulfur containing compound may include the sulfide of an M element (MₓS_{y}). Here, “x” and “y” are respectively an integer that gives the compound electrical neutrality with a S element according to the kind of M. Also, these sulfides (MₓS_{y}) are, for example, the residue of the starting material. Examples of the sulfide (MₓS_{y}) may include P₂S₅, GeS₂, SnS₂, SiS₂, B₂S₃, and Al₂S₃. The sulfur containing compound may contain just one kind of the sulfide (MₓS_{y}), and may contain two kinds or more thereof.

The sulfur containing compound preferably has at least the ortho structural skeleton, and may have just the ortho structural skeleton. The presence of the ortho structural skeleton may be confirmed by, for example, a Raman spectroscopy measurement. Meanwhile, the sulfur containing compound may and may not include the sulfide (MₓS_{y}). For example, when a cathode mixture is produced by conducting mechanical milling to a raw material mixture containing the elemental sulfur (cathode active material) and the sulfide (MₓS_{y}), if the proportion of the elemental sulfur is sufficient, the ortho structural skeleton may be easily formed, and thus the cathode mixture not containing the sulfide (MₓS_{y}) may be easily obtained. On the other hand, if the proportion of the elemental sulfur is comparatively little, a part of the sulfide (MₓS_{y}) easily remains, and thus the cathode mixture containing the sulfide (MₓS_{y}) may be easily obtained.

The cathode layer may and may not have the peak of the sulfide (MₓS_{y}) in an XRD measurement. The typical peaks of P₂S₅ appear at 20=25.84°±0.50°, 30.35°±0.50°, and 31.32°±0.50° in an XRD measurement using a CuKα ray. The typical peaks of GeS₂ appear at 20=15.43°±0.50°, 26.50°±0.50°, and 28.60°±0.50° in an XRD measurement using a CuKα ray. Also, the typical peaks of SnS₂ appear at 20=15.02°±0.50°, 32.11°±0.50°, and 46.14°±0.50° in an XRD measurement using a CuKα ray. Also, the typical peaks of SiS₂ appear at 20=18.36°±0.50°, 29.36°±0.50°, and 47.31°±0.50° in an XRD measurement using a CuKα ray. These peak positions may be respectively ±0.30°, and may be ±0.10°.

Also, as described above, a S element in the sulfur containing compound and a S element in the elemental sulfur (cathode active material) may have a chemical bond (S—S bond). In particular, it is preferable that the S element in the ortho structural skeleton and the S element in the elemental sulfur (cathode active material) have a chemical bond (S—S bond). Incidentally, the content of the sulfur containing compound in the cathode layer is the same as the content of the sulfide in the later described raw material mixture; thus the description herein is omitted.

(3) Conductive Auxiliary Material

The conductive auxiliary material has a function of improving the electron conductivity in the cathode layer. Also, it is presumed that the conductive auxiliary material functions as a reductant that reduces the elemental sulfur on the occasion such as when mechanical milling is conducted to the raw material mixture. The conductive auxiliary material is preferably present in the state dispersed in the cathode layer.

Examples of the conductive auxiliary material may include a carbon material and a metal material. Examples of the carbon material may include vapor growth carbon fiber (VGCF), acetylene black, activated carbon, furnace black, carbon nanotube, Ketjen black, and graphene. Incidentally, the content of the conductive auxiliary material in the cathode layer is the same as the content of the conductive auxiliary material in the later described raw material mixture; thus, the description herein is omitted.

(4) Cathode Layer

The cathode layer in the present disclosure comprises a cathode active material including a S element, a sulfur containing compound including an M element, which is P, Ge, Sn, Si, B or Al, and a S element, and a conductive auxiliary material. The cathode layer may comprises just the cathode active material, the sulfur containing compound, and the conductive auxiliary material, and may further comprise an additional material.

In the cathode mixture, there are no particular limitations on the molar ratio (M/S) of the M element to the S element; for example, it is 0.03 or more, may be 0.06 or more, and may be 0.09 or more. Meanwhile, the molar ratio (M/S) is, for example, 0.5 or less, may be 0.3 or less, may be 0.25 or less, and may be 0.23 or less. Incidentally, the denominator of the molar ratio (M/S) signifies the amount of all the S elements included in the cathode mixture; since both the cathode active material and the sulfur containing compound in the present disclosure include a S element, the amount of the both S elements are summed.

The thickness of the cathode layer is, for example, 0.1 μm or more and 1000 μm or less. Also, the cathode layer may be obtained by, for example, pressing the above described cathode mixture.

(5) Method for Producing Cathode Mixture

FIG. 2 is a flow chart explaining an example of the method for producing the cathode mixture in the present disclosure. In FIG. 2, first, a mixture containing an elemental sulfur (S), a sulfide (P₂S₅), and a conductive auxiliary material (VGCF) is prepared as the raw material mixture of the cathode mixture (preparing step). Next, mechanical milling is conducted to the raw material mixture (mechanical milling step). Thereby, the cathode mixture is obtained. The mechanical milling forms an excellent three-phase interface where the cathode active material, the sulfur containing compound that can be an ion conducting path, and the conductive auxiliary material that can be an electron conducting path, coexist. Thereby, the charge and discharge capacities may be improved.

(i) Preparing Step

The preparing step is a step of preparing a raw material mixture containing a cathode active material including a S element, a sulfide including an M element, which is P, Ge, Sn, Si, B or Al, and a S element, a conductive auxiliary material, and substantially no Li element. The raw material mixture may be fabricated by one's own, and may be purchased from others.

The raw material mixture may contain just the cathode active material, the sulfide, and the conductive auxiliary material, and may further contain an additional material. Also, it is preferable that the raw material mixture substantially contains no Li element. In the same manner, it is preferable that the raw material mixture substantially contains no Na element.

The cathode active material is preferably an elemental sulfur. The purity of the elemental sulfur is preferably high. Meanwhile, examples of the sulfide (MₓS_{y}) may include P₂S₅, GeS₂, SnS₂, SiS₂, B₂S₃, and Al₂S₃. The raw material mixture may contain just one kind of the sulfide of the additional element, and may contain two kinds or more thereof. The conductive auxiliary material is in the same contents as those described in “A. cathode mixture” above.

The content of the cathode active material in the raw material mixture may be, for example, 10 weight % or more, may be 20 weight % or more, and may be 25 weight % or more. If the content of the cathode active material is too little, the cathode mixture with sufficient capacity may not be obtained in some cases. Meanwhile, the content of the cathode active material in the raw material mixture may be, for example, 80 weight % or less, may be 70 weight % or less, and may be 60 weight % or less. If the content of the cathode active material is too much, the ion conductivity and the electron conductivity in the cathode layer may be insufficient in some cases.

The content of the sulfide in the raw material mixture may be, for example, 10 weight % or more, and may be 20 weight % or more. If the content of the sulfide is too little, the ion conductivity in the cathode layer may be insufficient in some cases. Meanwhile, the content of the sulfide in the raw material mixture may be, for example, 80 weight % or less, and may be 70 weight % or less. If the content of the sulfide is too much, the content of the cathode active material becomes relatively little, and the cathode mixture with sufficient capacity may not be obtained in some cases.

The content of the conductive auxiliary material in the raw material mixture may be, for example, 5 weight % or more, and may be 10 weight % or more. If the content of the conductive auxiliary material is too little, the electron conductivity in the cathode layer may be insufficient in some cases. Meanwhile, the content of the conductive auxiliary material in the raw material mixture may be, for example, 50 weight % or less, and may be 40 weight % or less. If the content of the conductive auxiliary material is too much, the content of the cathode active material becomes relatively little, and the cathode mixture with sufficient capacity may not be obtained in some cases.

In the raw material mixture, the weight ratio of the sulfide to the cathode active material is, for example, 0.4 or more, may be 0.5 or more, and may be 0.6 or more. Meanwhile, the weight ratio is, for example. 4 or less, may be 3 or less, may be 2 or less, and may be 1.2 or less.

(ii) Mechanical Milling Step

The mechanical milling step is a step of conducting mechanical milling to the raw material mixture. The raw material mixture is amorphized by mechanical milling and thereby the cathode mixture is obtained.

There are no particular limitations on the mechanical milling if it is a method in which the cathode mixture is mixed while applying a mechanical energy thereto, and examples thereof may include ball milling, vibration milling, turbo milling, mechano-fusion, and disc milling. Above all, planetary ball milling is particularly preferable.

The mechanical milling may be dry mechanical milling and may be wet mechanical milling. The liquid to be used in the wet mechanical milling is preferably aprotonic to the extent hydrogen sulfide is not generated. Specific examples of the aprotonic liquid may include polar aprotonic liquid and nonpolar aprotonic liquid.

The conditions for the mechanical milling are appropriately arranged so as to obtain the desired cathode mixture. For example, when planetary ball milling is used, the raw material mixture and balls for crushing thereof are added to a container, and the treatment is conducted with specific weighing table rotation number and for specific time. The weighing table rotation number is, for example, 200 rpm or more, may be 300 rpm or more, and may be 510 rpm or more. Meanwhile, the weighing table rotation number is, for example, 800 rpm or less, and may be 600 rpm or less. Also, the treatment time of the planetary ball milling is, for example, 30 minutes or more, and may be 5 hours or more. Meanwhile, the treatment time of the planetary ball milling is, for example, 100 hours or less, and may be 60 hours or less. Examples of the material of the container and ball for crushing to be used in the planetary ball milling may include ZrO₂ and Al₂O₃. The diameter of the ball for crushing is, for example, 1 mm or more and 20 mm or less. The mechanical milling is preferably conducted in an inert gas atmosphere (such as Ar gas atmosphere).

2. Anode Layer

The anode layer is a layer containing at least an anode active material. The anode active material preferably includes a Li element. Examples of such an anode active material may include a simple substance of lithium and a lithium alloy. Examples of the lithium alloy may include Li—In alloy. The anode active material preferably includes a Na element. Examples of such an anode active material may include a simple substance of sodium and a sodium alloy.

The anode layer may contain at least one of a solid electrolyte, a conductive auxiliary material, and a binder, as required. The conductive auxiliary material is in the same contents as those described for the cathode layer above. Examples of the binder may include a fluorine-based binder such as polyvinylidene fluoride (PVDF). Also, the thickness of the anode layer is, for example, 0.1 μm or more and 1000 μm or less.

3. Solid Electrolyte Layer

The solid electrolyte layer is a layer formed between the cathode layer and the anode layer. Also, the solid electrolyte layer is a layer containing at least a solid electrolyte, and may contain a binder as required. Also, the solid electrolyte layer contains a garnet-type oxide solid electrolyte or β-alumina, as a solid electrolyte. The garnet-type oxide solid electrolyte preferably has Li ion conductivity. The β-alumina preferably has Na ion conductivity.

Examples of the garnet-type oxide solid electrolyte may include a solid electrolyte that has a composition represented by a general formula (Li_{x-3y-z}, E_{y}, H_{z})L_{α}M_{β}O_{γ}. In the formula, E is at least one kind of Al, Ga, Fe, and Si, H is a hydrogen element, L is at least one kind of an alkali earth metal and lanthanoid element, M is at least one kind of a transition element that can be six-coordinated with oxygen, and a typical element belonging to 12^{nd} to 15^{th} groups in the periodic table, O is an oxygen element.

In the general formula, x, y, and z preferably satisfy 3≤x−3y−z≤7. If x−3y−z is too large, the crystal structure of the garnet-type oxide solid electrolyte easily changes from a cubic crystal structure to a tetragonal crystal structure. As the result, crystal symmetry is impaired and the lithium ion conductivity may be degraded in some cases. If x−3y−z is too small, the potential of the 96 h site, which is a peculiar site to Li, easily increases. As the result, Li is not easily positioned in the crystal, which results in decrease of Li occupancy, and the lithium ion conductivity may be degraded in some cases.

In the general formula, γ may satisfy y=0, and may satisfy 0<y. Meanwhile, γ may satisfy y≤0.25, and may satisfy y≤0.12. Also, z may satisfy z=0, and may satisfy 0<z. Meanwhile, z may satisfy z≤3.5, may satisfy z≤2.7, and may satisfy z≤2.3.

In the general formula, L is preferably at least one kind of an alkali earth metal and a lanthanoid element. Examples of the alkali earth metal may include Ca, Sr, Ba, and Ra. There are no particular limitations on the lanthanoid element, but La is preferable so as to improve the lithium ion conductivity. Also, in the general formula, a may satisfy 2.5≤α, and may satisfy 2.7≤α. Meanwhile, a may satisfy α≤3.5, and may satisfy α≤3.3. In particular, it is preferable that α satisfies α=3.

In the general formula, M is preferably at least one kind of a transition element that can be six-coordinated with oxygen, and a typical element belonging to 12^{nd} to 15^{th} groups in the periodic table. Examples of M may include Sc, Y, Ti, Zr, Hf, V, Nb, Ta, Cr, Mo, W, Mn, Fe, Co, Ni, Cu, Zn, Cd, Al, Ga, Ge, Sn, Sb, and Bi. M is preferably at least one kind of Zr, Nb, and Ta. Also, M preferably includes at least Zr, may include just Zr, and may include an additional element thereto. In the latter case, the additional element is preferably at least one kind of Nb and Ta. Also, in the general formula, β may satisfy 1.5≤β, and may satisfy 1.7≤β. Meanwhile, β may satisfy β≤2.5, and may satisfy β≤2.3. In particular, it is preferable that β satisfies β=2.

In the general formula, γ may satisfy 11≤γ, and may satisfy 11.5≤γ. Meanwhile, γ may satisfy γ≤13, and may satisfy γ≤12.5. In particular, it is preferable that γ satisfies γ=12.

Also, it is preferable that the garnet-type oxide solid electrolyte includes a Li element, a La element, at least one of a Zr element and a Ta element, and an O element.

The proportion of the solid electrolyte included in the solid electrolyte layer is, for example, 50 volume % or more, may be 70 volume % or more, and may be 90 volume % or more. Incidentally, the binder to be used in the solid electrolyte layer is in the same contents as those described for the anode layer above. Also, the thickness of the solid electrolyte layer is, for example, 0.1 μm or more and 1000 μm or less.

4. All Solid State Battery

The all solid state battery in the present disclosure comprises the above described cathode layer, anode layer, and solid electrolyte layer, and usually further comprises a cathode current collector for collecting currents of the cathode layer, and an anode current collector for collecting currents of the anode layer. Examples of the material for the cathode current collector may include SUS, aluminum, nickel, iron, titanium, and carbon. On the other hand, examples of the material for the anode current collector may include SUS, copper, nickel, and carbon.

The all solid state battery in the present disclosure is preferably a sulfur battery. The sulfur battery signifies a battery using an elemental sulfur as a cathode active material. The all solid state battery in the present disclosure may be a lithium sulfur battery (LiS battery), and may be a sodium sulfur battery (NaS battery). Also, the all solid state battery may be a primary battery and may be a secondary battery, but the latter is preferable among them since it may be repeatedly charged and discharged, and is useful as, for example, a car-mounted battery. Incidentally, the secondary battery includes a usage of a secondary battery as a primary battery (the use for the purpose of just one time discharge after charge).

Incidentally, the present disclosure is not limited to the embodiments. The embodiments are exemplification, and any other variations are intended to be included in the technical scope of the present disclosure if they have substantially the same constitution as the technical idea described in the claim of the present disclosure and offer similar operation and effect thereto.

### EXAMPLES

Hereinafter, the present disclosure will be described more specifically with reference to Examples. Incidentally, each operation such as weighing, synthesizing and drying was carried out under Ar atmosphere, unless otherwise indicated.

### Example 1

<Fabrication of Cathode Mixture>

An elemental sulfur (cathode active material, from Kojundo Chemical Lab. Co., Ltd.), P₂S₅ (sulfide), and VGCF (conductive auxiliary material) were prepared. These were weighed so as the elemental sulfur to be 1.050 g, P₂S₅ to be 0.852 g, and VGCF to be 0.570 g, and each raw material was kneaded in an agate mortar for 15 minutes to obtain a raw material mixture. The obtained raw material mixture was projected into a container (45 cc, made of ZrO₂) for planetary ball milling, further, ZrO₂ balls (ϕ=4 mm, 96 g) were projected thereinto, and the container was completely sealed. This container was installed to a planetary ball milling machine (P7 from Fritsch Japan Co., Ltd), and a cycle of, mechanical milling for 1 hour (weighing table rotation number of 510 rpm), 15 minutes pause, mechanical milling for 1 hour in reverse turn (weighing table rotation number of 510 rpm), and 15 minutes pause, was repeated to carry out the mechanical milling for total of 48 hours. Thereby, a cathode mixture was obtained.

<Fabrication of all Solid State Battery>

The cathode mixture of 31.3 mg was placed in 1 cm² ceramic mold and pressed under 1 ton/cm² to obtain a cathode layer. On the cathode layer, the pellet of a garnet-type oxide solid electrolyte (Li_{6.6}La₃Zr_{1.6}Ta_{0.4}O₁₂) having thickness of 1.5 mm was placed and thereby a solid electrolyte layer was obtained. On the solid electrolyte layer, a lithium metal foil as an anode layer was placed and thereby a power generating element was obtained. An Al foil (cathode current collector) was placed on the cathode layer side, and a Cu foil (anode current collector) was placed on the abode layer side. Thereby, an all solid state battery was obtained.

### Comparative Example 1

The cathode mixture fabricated in Example 1 of 31.3 mg was placed in 1 cm² ceramic mold and pressed under 1 ton/cm² to obtain a cathode layer. On the cathode layer, 100 mg of LiI—LiBr—Li₃PS₄-based glass ceramic was placed and pressed under 1 ton/cm² to obtain a solid electrolyte layer. On the solid electrolyte layer, a lithium metal foil as an anode layer was placed and thereby a power generating element was obtained. An Al foil (cathode current collector) was placed on the cathode layer side, and a Cu foil (anode current collector) was placed on the abode layer side. Thereby, an all solid state battery was obtained.

[Evaluation]

<X-Ray Diffraction Measurement>

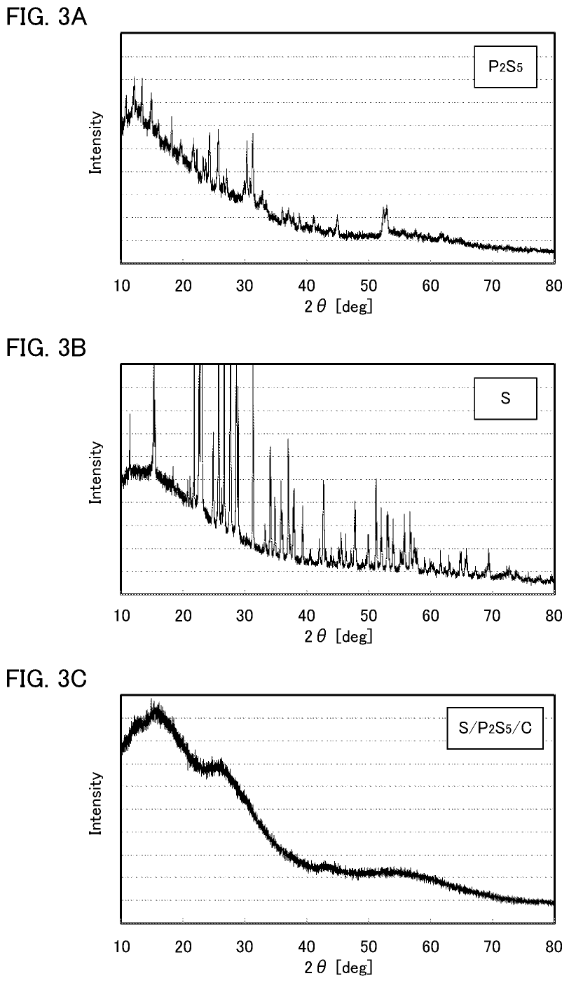

An X-ray diffraction (XRD) measurement using a CuKα ray was conducted for the raw materials (sulfide and elemental sulfur) in Example 1, and for the cathode mixture obtained in Example 1. The results are sown in FIGS. 3A to 3C. As shown in FIG. 3A and FIG. 3B, the raw materials, which were the sulfide (P₂S₅) and the elemental sulfur (S), had peaks at the specific positions and high crystallinity thereof was confirmed. On the other hand, as shown in FIG. 3C, it was confirmed that the cathode mixture after mechanical milling was sufficiently amorphized.

<Resistance Measurement>

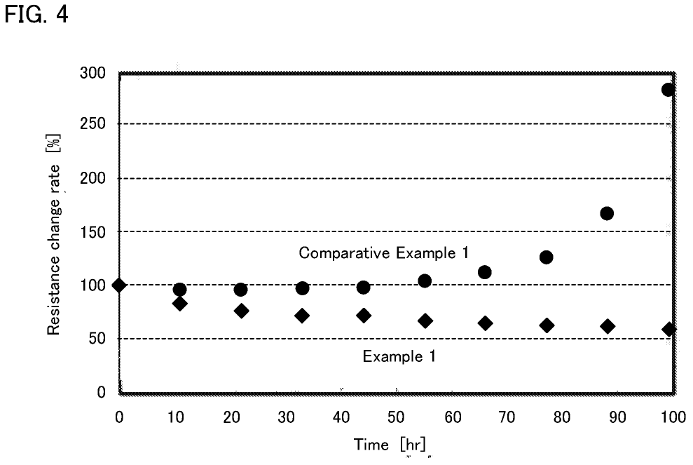

A resistance measurement was conducted for the all solid state batteries obtained in Example 1 and Comparative Example 1, and the resistance change rate during discharge was evaluated. The batteries were discharged to 1.5 V (vs Li/Li⁺) at the current density of 10 μA/cm², and an alternating current impedance measurement (±10 mV, 1 mHz to 10 mHz) was carried every 1 hour. The resistance shift in the high frequency (96716.3 Hz) is shown in FIG. 4. Incidentally, the resistance change rate shown in FIG. 4 is on the basis of the resistance when the measurement was initiated (100%).

As shown in FIG. 4, in Comparative Example 1, direct current resistance gradually increased during discharge. On the other hand, in Example 1, the direct current resistance did not increase during discharge, but a remarkable effect was obtained such that the resistance decreased on the contrary. The reason therefor is presumably because a non-uniform interface was formed between the soft cathode layer containing a S element and the hard solid electrolyte layer containing the oxide, Li was concentrated in the thickness direction during discharge, and thus the resistance component was inhibited from being generated in the interface uniformly in the width direction.

### Reference Examples 1 to 3

A cathode mixture and an all solid state battery were respectively obtained in the same manner as in Example 1, except that GeS₂, SnS₂, and SiS₂ were respectively used as the sulfide, and each raw material was weighed so as to be in the weight ratio shown in Table 1.

TABLE 1

| | S [g] | MxSy [g] | | C [g] |
|---|---|---|---|---|
| Reference Example 1 | 1.050 | GeS₂ | 0.852 | 0.570 |
| Reference Example 2 | 0.867 | SnS₂ | 1.035 | 0.570 |
| Reference Example 3 | 1.188 | SiS₂ | 0.714 | 0.570 |

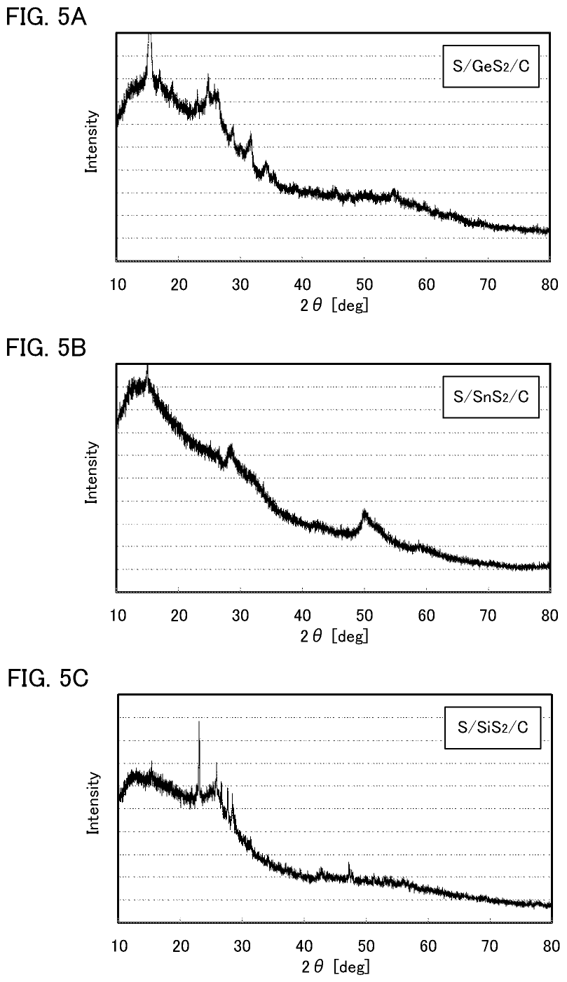

An XRD measurement was conducted for the cathode mixtures obtained in Reference Examples 1 to 3. The results are shown in FIGS. 5A to 5C. As shown in FIGS. 5A to 5C, it was confirmed that the cathode mixtures obtained in Reference Examples 1 to 3 were sufficiently amorphized. Also, it was confirmed that the all solid state batteries obtained in Reference Examples 1 to 3 functioned as a battery.

### REFERENCE SIGNS LIST

1 cathode layer
2 solid electrolyte layer
3 anode layer
4 cathode current collector
5 anode current collector
10 all solid state battery

What is claimed is:

1. An all solid state battery comprising a cathode layer, a solid electrolyte layer, and an anode layer in this order; wherein
the cathode layer comprises a cathode active material including a S element, a sulfur containing compound including an M element, which is P, Ge, Sn, Si, B or Al, and a S element, a conductive auxiliary material, and substantially no Li element; and
the solid electrolyte layer contains a garnet-type oxide solid electrolyte or β-alumina.

2. The all solid state battery according to claim 1, wherein a proportion of the Li element is 0 mol % or more and 20 mol % or less.

3. The all solid state battery according to claim 1, wherein the M element is a P element.

4. The all solid state battery according to claim 1, wherein the garnet-type oxide solid electrolyte has a composition represented by a general formula (Li_{x-3y-z}, E_{y}, H_{z})L_{α}M_{β}O_{γ}, in the formula, E is at least one kind of Al, Ga, Fe, and Si, H is a hydrogen element, L is at least one kind of an alkali earth metal and lanthanoid element, M is at least one kind of a transition element that can be six-coordinated with oxygen, and a typical element belonging to 12^{nd} to 15^{th} groups in the periodic table, O is an oxygen element, x, y, z satisfy 3≤x−3y−z≤7, 0≤y, and 0≤z, α, β, γ respectively satisfies 2.5≤α≤3.5, 1.5≤β≤2.5, and 11≤γ≤13.
